(19) United States
(12) Patent Application Publication
(10) Pub. No.: US 2020/0032964 A1
(43) Pub. Date: Jan. 30, 2020

(54) LIGHTING DEVICE AND LUMINAIRE COMPRISING THE SAME

(71) Applicant: SIGNIFY HOLDING B.V., EINDHOVEN (NL)

(72) Inventors: Xiaoqing DUAN, EINDHOVEN (NL); Yun WANG, EINDHOVEN (NL); Linggen MO, EINDHOVEN (NL)

(21) Appl. No.: 16/495,280

(22) PCT Filed: Mar. 26, 2018
(86) PCT No.: PCT/EP2018/057603

§ 371 Date: Sep. 18, 2019

(30) Foreign Application Priority Data
Apr. 5, 2017 (CN) PCT/CN2017/079492
Jun. 13, 2017 (EP) 17175665.3

(51) Int. Cl. F21K 9/275; F21V 23/00; F21V 23/02

(52) U.S. Cl. CPC F21K 9/275; F21Y 2103/10; F21V 23/023; F21V 23/006

(57) ABSTRACT

A lighting device (100) comprises an elongate tubular body (102) with a carrier (104) located inside the tubular body. The carrier comprises a first section (106) and a second section (108), each of which carries at least one solid state lighting element (110). The first section extends in the elongation direction of the tubular body. The second section extends from an end of the first section at an angle with respect to the first section such that the second section and the tubular body at least partially delimit an internal cavity of the tubular body. Further provided is a luminaire comprising said lighting device.

### FIELD OF THE INVENTION

The present invention relates to a lighting device comprising solid state lighting elements mounted inside a tubular body, and a luminaire comprising said lighting device.

### BACKGROUND OF THE INVENTION

With a continuously growing population, it is becoming increasingly difficult to meet the world's energy needs as well as to curb greenhouse gas emissions that are considered responsible for climate change phenomena. These concerns have triggered a drive towards more efficient use of electricity in an attempt to reduce energy consumption.

One such area of concern is lighting applications, either in domestic or commercial settings. There is a clear trend towards the replacement of traditional energy-inefficient light bulbs, such as incandescent or fluorescent light bulbs, with more energy efficient replacements. Indeed, in many jurisdictions the production and retailing of incandescent light bulbs has been outlawed, thus forcing consumers to buy energy-efficient alternatives, e.g. when replacing incandescent light bulbs.

A particularly promising alternative is provided by solid state lighting (SSL) devices, which can produce a unit luminous output at a fraction of the energy cost of incandescent light bulbs. An example of such a SSL element is a light emitting diode.

A drawback of SSL element-based lighting devices is that the compatibility with incandescent light-based device fittings, e.g. luminaires, is not perfect, which hampers the market penetration of the SSL element-based lighting devices. SSL element-based lighting devices typically require one or more driver circuits for driving the SSL elements, which when integrated in the lighting device can compromise the internal volume available for luminous output, i.e. for the SSL elements. This is for instance problematic in tubular lighting devices based on SSL elements such as tubular light bulbs in which the driver circuit is typically located inside the tube towards an end portion of the tube, e.g. adjacent to an end cap of the tube for connecting the tube into the fitting of a luminaire. An example of such an arrangement is disclosed in CN 101893178 A. The absence of SSL elements in such an end segment of the tubular lighting device gives the end segments of the lighting device a dark appearance, which renders the SSL elements-based tubular lighting device aesthetically inferior compared to traditional tubular light bulbs such as fluorescent light bulbs.

In view of this problem, a tubular lighting device is disclosed in, for instance, WO 2014/195891 A1 in which the SSL elements are mounted on separate sections of a carrier which are respectively located in different planes, one section being elevated relative to the other. A driver may be positioned under the elevated section such that it does not lie in the optical path of any of the SSL elements. Dark areas may thus be diminished with such a design because the elevated section of the carrier means that its luminous output extends over a greater proportion of the length of the tubular lighting device.

Nevertheless, improved carrier designs are required in order to provide further enhancement of the luminous output of the lighting device.

### SUMMARY OF THE INVENTION

The invention is defined by the claims.

In accordance with an aspect, there is provided a lighting device comprising: an elongate tubular body; and a carrier located inside said tubular body, the carrier comprising a first section and a second section each carrying at least one solid state lighting element, wherein the first section extends in the elongation direction of the tubular body, and the second section extends from an end of the first section at an angle with respect to the first section such that the second section and said tubular body at least partially delimit an internal cavity of the tubular body.

The internal cavity may, for example, be used to house components for operating the solid state lighting elements. By locating such components inside the cavity, they may not lie in the optical path of the solid state lighting elements and thus may not reduce the luminous efficiency of the lighting device. Importantly, the second section carries at least one solid state lighting device such that the provision of the second section not only defines the cavity but moreover contributes to an overall luminous output of the carrier. This represents an advantage over existing solutions in which such angled portions of the carrier are absent or, if present, do not carry solid state lighting elements such that the angled portion cannot contribute to the luminous output of such prior art lighting devices.

The angle may be such that the second section extends from the end of the first section in an inclined manner. The inclined extension of the second section from the end of the first section may mean that the at least one solid state lighting element carried by the second section may emit a greater angular proportion of its luminous distribution towards the tubular body than, for instance, a scenario in which the second section is perpendicular to the first section.

The carrier may further comprise a third section carrying at least one solid state lighting element, the third section extending from an end of the second section opposite the first section such that the carrier comprises a stepped profile. The third section may thus be considered as an additional luminous section of the carrier under which components, e.g. for operating the solid state lighting elements, may be located.

The stepped profile may comprise at least one further step defined by an inclined riser section adjoining a step section extending in a direction of extension of the third section, wherein at least one of the riser section and the step section carries at least one solid state lighting element.

As a consequence of the angled or inclined nature of the second section with respect to the first section, the optical axis of a solid state lighting element mounted on the second section is oriented under an angle with the optical axis of a solid state lighting element mounted on the first section and, if present, the third section. Whereas solid state lighting elements on the first and, if present, third sections are typically oriented such that their optical axes extend through a portion of the tubular body proximal, e.g. immediately opposite, the solid state lighting elements, this is not the case for the solid state lighting elements mounted on the angled second section. As will be understood by the skilled person, this may result in the portions of the tubular body immediately opposite the solid state lighting elements on the angled second section to be less illuminated, which may lead to noticeable darker regions in the tubular body. This effect may be particularly noticeable when the second section extends over a considerable length of the tubular body. This undesirable effect may be suppressed by the carrier having a stepped profile including a plurality of shorter angled, or inclined, riser sections separated by step sections aligned with the light exit surface of the tubular body, such that a more homogeneous illumination of the light exit surface is achieved.

Furthermore, the stepped profile may, for example, assist to tailor the shape of the cavity for the driver. The components of the driver may have different heights such that, for example, arranging the components such that they are positioned in order of decreasing height in the direction of the first section, i.e. such that the components fit under the respective sections of the stepped profile, the volume of the cavity may be efficiently utilized.

The lighting device may comprise a driver configured to regulate power supplied to at least one solid state lighting element. The driver may be positioned such that it is at least partially contained within the internal cavity. This provides a lighting device with an integrated driver in which the volume occupied by the driver may not, or may only minimally, reduce the luminous output area of the lighting device.

A housing may be located within the internal cavity, and the driver may be located within the housing. The housing may also support the second section. The housing may, for instance, facilitate dissipation of the heat generated by the driver to the tubular body. This may be assisted by the housing comprising a slot, the driver being mounted on a support dimensioned to fit into the slot so as to be in thermal contact with the housing.

The lighting device may comprise an end cap at an end of the tubular body, wherein the internal cavity may be at least partially delimited by the second section and the end cap. The end cap may support the driver. Accordingly, the end cap may contribute to the robustness, and ease of assembly of the lighting device.

The carrier may comprise a further second section carrying at least one solid state lighting element and extending from a further end of the first section which opposes said end of the first section at a further angle with respect to said first section such that the further second section and the tubular body at least partially delimit a further internal cavity of the tubular body.

By the carrier comprising both the second section and the further second section, the lighting device may thus comprise two internal cavities, thus providing additional volume which may, for instance, be used to house components for operating the solid state lighting elements. The provision of the second and further second sections may also assist to provide a more symmetrical lighting effect across the length of the carrier relative to, for instance, a carrier with no further second section.

The carrier may comprise a further third section carrying at least one solid state lighting element, the further third section extending from an end of the further second section opposite the first section such that the carrier comprises a further stepped profile. The further stepped profile may comprise at least one additional step defined by a further inclined riser section adjoining a further step section extending in a direction of the extension of the further third section, wherein at least one of said further riser section and the further step section carries at least one solid state lighting element.

The carrier may comprise a flexible printed circuit board comprising the respective sections. The flexibility of the printed circuit board may mean that the different sections of the carrier may be formed by appropriate bending of the flexible printed circuit board where the sections adjoin each other. Thus the carrier may, for instance, correspond to a singular printed circuit board on which the solid state lighting elements may be mounted.

Alternatively, the carrier may comprise separate printed circuit boards for each of the respective sections. The use of separate printed circuit boards for the respective sections may simplify the design of the lighting device such that it can be produced in a particularly cost-effective manner.

In accordance with another aspect, there is provided a luminaire comprising the lighting device according to any of the herein embodiments. Such a luminaire may, for instance, be a holder of the lighting device or an apparatus into which the lighting device is integrated.

### BRIEF DESCRIPTION OF THE DRAWINGS

Embodiments of the invention are described in more detail and by way of non-limiting examples with reference to the accompanying drawings, wherein:

FIG. 1 schematically depicts a cross-section of a lighting device according to an embodiment;

FIG. 2 schematically depicts two further cross-sections of the lighting device shown in FIG. 1;

FIG. 3 depicts part of a lighting device according to another embodiment with a cutaway portion;

FIG. 4 depicts the lighting device shown in FIG. 3 with a further cutaway portion;

FIG. 5 depicts an exploded view of a lighting device according to a further embodiment;

FIG. 6 depicts the lighting device shown in FIG. 5 when assembled.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

A lighting device comprises an elongate tubular body with a carrier located inside the tubular body. The carrier comprises a first section and a second section, each of which carries at least one solid state lighting element. The first section extends in the elongation direction of the tubular body. The second section extends from an end of the first section at an angle with respect to the first section such that the second section and the tubular body at least partially delimit an internal cavity of the tubular body.

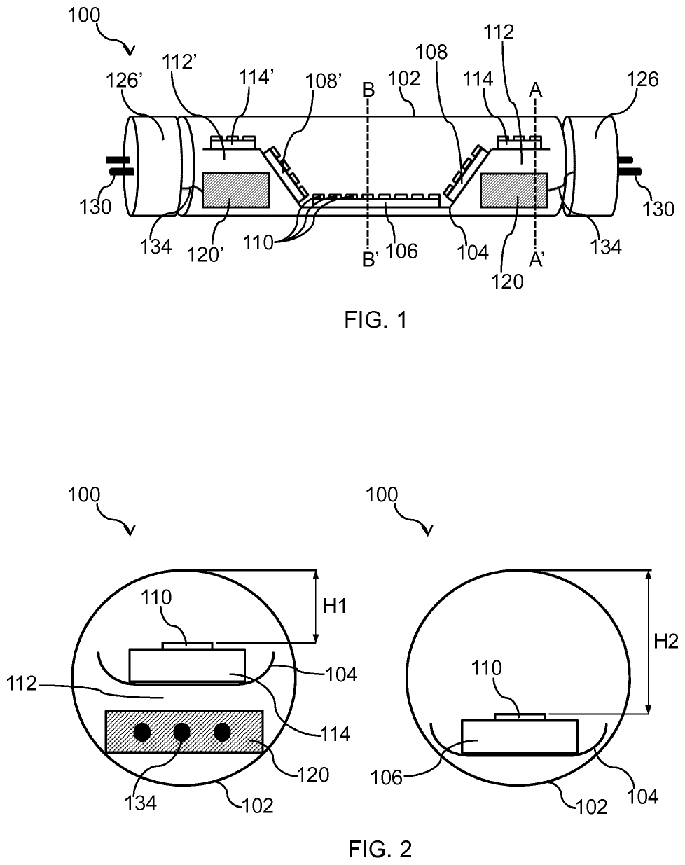

FIG. 1 schematically depicts a cross-section of a lighting device 100 according to an embodiment. The lighting device 100 comprises a carrier 104 located inside an elongate tubular body 102. The tubular body 102 may comprise any suitable shape, such as a cylindrical shape. The carrier 104 carries solid state lighting elements 110 which are arranged to emit light towards the tubular body 102. The solid state lighting elements 110 may be light emitting diodes (LEDs), e.g. organic or inorganic LEDs.

The luminous surfaces of the solid state lighting elements 110 may emit light towards a portion of the tubular body 102 which may act as a light exit surface. The tubular body 102 may comprise a suitable light transmissive material such that light emitted by the solid state lighting elements 110 may pass beyond the tubular body 102 and thus illuminate a space beyond. Suitable light transmissive materials may, for example, include glass, a suitable polymer such as polycarbonate or PMMA etc. The light transmissive material may be transparent or translucent, e.g. clouded, so as to provide a more diffuse lighting effect. Such materials are well-known per se and will not be further described herein for the sake of brevity only.

The carrier 104 comprises a first section 106 which extends in the elongation direction of the tubular body 102. The first section 106 may, for instance, be located on or near an inner wall of the tubular body 102, as shown in the example depicted in FIG. 1. The first section 106 adjoins a second section 108 which extends from an end of the first section 106 at a non-zero angle with respect to the first section 106. In this way the second section 108 and the tubular body 102 at least partially delimit an internal cavity 112 of the tubular body 102. Importantly, the second section 108 carries at least one solid state lighting element 110 such that the second section 108, as well as defining the cavity 112, contributes to an overall luminous output of the carrier 104.

This represents an advantage over existing solutions in which such angled portions of the carrier are absent or, if present, do not carry solid state lighting elements such that the angled portion cannot contribute to the luminous output of such prior art lighting devices.

The internal cavity 112 may contain a driver 120 configured to regulate power supplied to the solid state lighting elements 110. Suitable circuitry and components for the driver 120 are well-known per se and will not be further described herein for the sake of brevity only. By virtue of the second section 108 and the tubular body 102 at least partially delimiting the cavity 112, the driver 120 may be accommodated at least partially inside this cavity 112. Accordingly, the driver 120 may not, or to a lesser extent, result in unlit, or ‘dark’, areas being visible when the lighting device 100 is operating.

In an embodiment, the angle between the first section 106 and the second section 108 may be such that the second section 108 extends from the end of the first section 106 in an inclined manner. In other words, in this embodiment the second section 108 may not extend perpendicularly with respect to the first section 106.

In a non-limiting example (not shown in the figures), the carrier 104 may comprise an inclined second section 108 which defines a terminal section of the carrier 104. In other words, the inclined second section 108 extends from an end of the first section 106 to a point where it meets or closely approaches an inner surface of the tubular body 102. Accordingly, the carrier 104 may have a simple design involving only two sections which may be easily fabricated.

In an embodiment, the carrier 104 may comprise a third section 114 extending from an end of the second section 108 opposite the first section 106. The carrier 104 may thus be described as comprising a stepped profile. As shown in FIG. 1, the cavity 112 may be delimited by the second section 108, the third section 114 and the tubular body 102. The third section 114 may carry at least one solid state lighting element 110. In this way, the third section 114, as well as extending the cavity 112, may also contribute to an overall luminous output of the carrier 104.

Although this is not depicted in FIG. 1, the stepped profile may comprise at least one further step defined by an inclined riser section adjoining a step section extending in a direction of extension of the third section 114. At least one of the riser section and the step section may carry at least one solid state lighting element 110. By, for instance, the step section, or sections, carrying at least one solid state lighting element 110, the stepped profile may direct more luminous output towards portions of the tubular body 102 which extend over the stepped profile than, for instance, in the scenario where only the riser sections carry solid state lighting elements 110.

As a consequence of the angled or inclined nature of the second section 108 with respect to the first section 106, the optical axis of a solid state lighting element 110 mounted on this section is oriented under an angle with the optical axis of a solid state lighting element 110 mounted on the first section 106 and the third section 114. Whereas solid state lighting elements 110 on the first 106 and third 114 sections are typically oriented such that their optical axes extend through a portion of the tubular body 102 proximal, e.g. immediately opposite, the solid state lighting elements 110, this is not the case for the solid state lighting elements 110 mounted on the angled second section 108. As will be understood by the skilled person, this may result in the portions of the light exit surface of the tubular body 102 immediately opposite the solid state lighting elements 110 on the angled second section 108 to be less illuminated, which may lead to noticeable darker regions in the tubular body 102.

This effect may be particularly noticeable when the second section 108 extends over a considerable length of the tubular body 102. This undesirable effect may be suppressed by the carrier 104 having a stepped profile including a plurality of shorter angled, or inclined, riser sections separating step sections aligned with the light exit surface of the tubular body 102, such that a more homogeneous illumination of the light exit surface is achieved.

Moreover, the stepped profile may, for example, assist to tailor the shape of the cavity 112 for the driver 120. The components of the driver 120 may have different heights such that, for example, arranging the components such that they are positioned in order of decreasing height in the direction of the first section 106, i.e. such that the shortest components are positioned under a portion of the inclined second section 108 closer to the first section 106, and taller components are positioned further from the first section 106 under the second section 108, or under the third section 114, the volume of the cavity 112 may be efficiently utilized.

It is noted at this point that the second section 108 as shown in, for instance, FIG. 1, is inclined with respect to the first section 106. However, this is not intended to be limiting. Alternatively, the second section 108 may extend perpendicularly with respect to the first section 106, although this is not optically preferred due to the luminous output of the second section 108 being mainly directed in the elongation direction of the tubular body 102 rather than towards the tubular body 102 itself. When the second section 108 extends perpendicularly with respect to the first section 106, the carrier 104 may comprise a third section 114 which adjoins the second section 108 in order to define the cavity 112. In such an example, the third section 114 may serve to extend the luminous output of the carrier 104 whilst partially delimiting the cavity 112.

The length of the first section 106 may, for example, be larger than the length of the second section 108 and the third section 114 of the carrier 104. In such an example, the first section 106 may carry a higher number of solid state lighting elements 110 than each of the second section 108 and the third section 114.

The lighting device 100 may comprise an end cap 126 at an end of the tubular body 102, wherein the internal cavity 112 may be at least partially delimited by the second section 108 and the end cap 126. The end cap 126 may support the driver 120 when, for example, the driver 120 extends from the cavity 112 into the end cap 126 region of the tubular body 102.

The end cap 126 may, for instance, comprise one or more pins 130 for engaging with a socket of a luminaire (not shown). In this way, electrical power may be supplied to the lighting device 100. The pin-socket arrangement may further mean that the lighting device 100 is supported within the luminaire. Alternatively, the luminaire fitting may comprise at least one pin, and the lighting device 100 may comprise a socket for receiving the at least one pin. Such fittings are well-known to the skilled person and will not be further described herein for the sake of brevity only.

In an embodiment, the carrier 104 may optionally comprise a further second section 108′ which extends from a further end of the first section 106 which opposes the end of the first section 106 from which the second section 108 extends. The further second section 108′ may extend at a further angle with respect to the first section 106. In this way, the further second section 108′ and the tubular body 102 may at least partially delimit a further internal cavity 112′ of the tubular body 102. The further second section 108′ may carry at least one solid state lighting element 110 such that such that the further second section 108′, as well as providing the further internal cavity 112′, contributes to an overall luminous output of the carrier 104.

As described in relation to the second section 108, the further angle may be such that the further second section 108′ extends from the end of the first section 106 in an inclined manner. This may result in the solid state lighting element 110 carried by the further second section 108′ emitting a greater angular proportion of its luminous distribution towards the light exit surface of the tubular body 102 than, for instance, the scenario in which the further second section 108′ is perpendicular to the first section 106.

The carrier 104 may comprise a further third section 114′ extending from an end of the further second section 108′ opposite the first section 106 such that the carrier 104 comprises a further stepped profile. The further third section 114′ carries at least one solid state lighting element 110. As described in relation to the third section 114, the further third section 114′ may further assist to minimize or prevent the appearance of less well-lit, or ‘darker’, regions of the carrier 104 coinciding with the further stepped profile. Furthermore, the further stepped profile may be used in combination with a complementary spatial arrangement of components, i.e. in terms of their height, of the further driver 120′such that the available volume of the further internal cavity 112′ is efficiently utilized.

Although not shown in FIG. 1, the further stepped profile may comprise at least one additional step defined by a further inclined riser section adjoining a further step section extending in a direction of said extension of the further third section 114. At least one of the further riser section and the further step section may carry at least one solid state lighting element 110. As described in relation to the stepped profile, by the further step section carrying at least one solid state lighting element 110, the appearance of less well-lit, or ‘darker’, regions of the carrier 104 coinciding with the stepped profile may be minimized.

The further driver 120′ may be configured to regulate power supplied to at least one further solid state lighting element 110, i.e. which is not driven by the driver 120. The solid state lighting elements 110 may, for instance, be divided into two sets respectively located in two portions of the tubular body 102 either side of an arbitrary divide perpendicular to the elongation direction of the tubular body 102. The sets may, for instance, by driven by the respective driver 120 or 120′ which is located in the same portion of the tubular body 102.

It is noted at this point that the lighting device 100 depicted in FIG. 1 comprises a symmetrical carrier 104 comprising a second section 108 and a third section 114 on one side of the first section 106, and a further second section 108′ and a further third section 114′ on the other side. Such a symmetric carrier 104 may provide a more symmetrical lighting effect across its length, than observed with an asymmetric carrier 104. However, the design depicted in FIG. 1 is not intended to be limiting. An alternative symmetric carrier 104 may, for instance, have an inclined second section 108 and an inclined further second section 108′, with no third section 114 and no further third section 114′.

Asymmetric carriers 104 are equally feasible. For example, the carrier 104 may only have a first section 106 and a second section 108, i.e. such that the lighting device 100 has a single cavity 112. In another asymmetric alterative, the carrier 104 may have a second section 108 and a third section 114, and a further second section 108′ with no adjoining further third section.

Alternatively or, where applicable, additionally an asymmetric carrier 104 may involve differently dimensioned sections either side of the first section 106. The angle and the further angle may be the same or different.

The left hand and right hand panes of FIG. 2 schematically depict cross-sectional views of the lighting device 100 depicted in FIG. 1 along planes A-A′ and B-B′ respectively. These cross-sections are perpendicular to the elongation direction of the tubular body 102. The left hand pane shows a slice containing the third section 114 and the driver 120. The right hand pane shows a slice containing the first section 106.

As shown in FIG. 2, the driver 120 may be fitted in between the third section 114 of the carrier 104 and an inner wall of the tubular body 102. A solid state lighting element 110 may be carried on the third section 114 with its luminous surface facing the tubular body 102. A clearance H1 separates the luminous surface of the solid state lighting element 110 and an uppermost portion of the tubular body 102. Even though FIG. 2 shows a third section 114, it is reiterated that such a third section 114 need not be present, providing that an inclined second section 108 defines a terminal section of the carrier 104.

The driver 120 may comprise one or more connectors 134 for engaging with an end cap (not shown in FIG. 2) of the tubular body 102. The driver 120 may, for instance, comprise one or more pins 134 that fit into opposite sockets located in the end cap. Alternatively, the driver 120 may comprise one or more sockets 134 for receiving opposite pins of the end cap. The engagement between the driver 120 and the end cap may assist in securing the driver 120 inside the tubular body 102. It should be understood that further securing measures, e.g. screws, clips, an adhesive and so on may be used to further secure the driver 120 inside the tubular body 102.

The right hand pane of FIG. 2 shows a slice containing the first section 106 of the carrier 104. The first section 106 may be considered to be located on a different plane in the tubular body 102 compared to the third section 114. A luminous surface of a solid state lighting element 110 on the first section 106 may be separated from the uppermost portion of the tubular body 102 by a clearance H2. As shown in FIG. 2, H1 may be smaller than H2 as a consequence of the first section 106 and the third section 114 being located in different planes.

It is noted that the first section 106 is shown in the figures as being located on or near an inner wall portion of the tubular body 102 which is opposite an upper portion of the tubular body 102 which acts as a light exit surface. The second section 108 thus extends at an angle, or incline, towards this upper surface portion of the tubular body 102. The cavity 112 may thus be located at an end of the tubular body 102. Having the cavity 112 at an end of the tubular body 102 may facilitate fabrication of the lighting device 100 since the carrier 104 may be received into the tubular body 102, followed by the driver 120 and end cap 126, each as separate components, e.g. in that order.

However, this is not intended to be limiting. Alternatively, the first section 106 may be proximal to the light exit surface of the tubular body 102. A second section 108 may extend at an angle, or incline, towards the inner wall portion opposite the light exit surface. A further second section 108′ may oppose the second section 108. Accordingly, the internal cavity 112 and further internal cavity 112′ may adjoin to form a combined internal volume located in a central portion of the tubular body 102. In such a non-limiting example, the driver 120 and, if present, the further driver 120′ may be located centrally in the tubular body 102, rather than at an end of the tubular body 102.

As shown in FIG. 2, the carrier 104 may comprise separate printed circuit boards for each of the respective sections. Thus in the case of FIG. 2, the first section 106 and the third section 114 respectively comprise separate printed circuit boards. These may, for example, be adhered to a common carrier 104. Whilst not shown in FIG. 2, the second section 108 may correspond to a further separate printed circuit board. The use of separate printed circuit boards for the respective sections may simplify the design of the lighting device 100 such that the lighting device 100 can be produced in a particularly cost-effective manner.

When the respective sections correspond to separate printed circuit boards, the carrier 104 may, for example, act as a heat sink for dissipating the heat produced by the solid state lighting elements 110. Accordingly, the carrier 104 may comprise a material having good heat conductive properties, e.g. a metal. Aluminum is particularly preferred as it is pliable such that the carrier 104 can be easily molded, e.g. extruded, into its desired shape. A pliable metal also allows for the formation of the different sections in a straightforward manner. The printed circuit boards may be secured to the carrier 104 by any suitable means such as using a thermally conductive glue or adhesive strip(s).

Alternatively, the solid state lighting elements 110 may be mounted directly on the carrier 104, for instance, using a glue or adhesive strip. In an example, the glue or adhesive strip may be thermally conducting such that dissipation of the heat generated by the solid state lighting element 110 to the carrier 104 may be assisted.

The carrier 104 may, for instance, comprise curved side walls which may assist in establishing more intimate contact between the part of the carrier 104 comprising the first section 106 and the similarly curved inner wall of the tubular body 102, as shown in the right hand pane of FIG. 2. This may promote heat transfer between the first section 106 and the tubular body 102, thereby increasing the efficiency of the dissipation of heat generated by the solid state lighting elements 110 inside the tubular body 102. Other shapes of the carrier 104 are also conceivable, e.g. a planar shape.

As shown in FIG. 2, the carrier 104 may comprise a planar central portion on which the printed circuit boards or the solid state lighting elements 110 may be mounted. For the avoidance of doubt it is noted that where the present application refers to the ‘planes’ of the various sections of the carrier 104, this term refers to the plane in which the planar central portion lies.

In an embodiment, the carrier 104 may comprise a flexible printed circuit board comprising the respective sections. Accordingly, the carrier 104 may, for instance, correspond to a singular printed circuit board on which the solid state lighting elements 110 may be mounted. Whilst being flexible so as to be able to form the second section 108 and, if present, the third section 114, and any further sections, the flexible printed circuit board may have sufficient stiffness such that these sections may be retained without support. Alternatively, the respective sections may be defined and/or supported by suitable fixings and/or supporting structures within the tubular body 102.

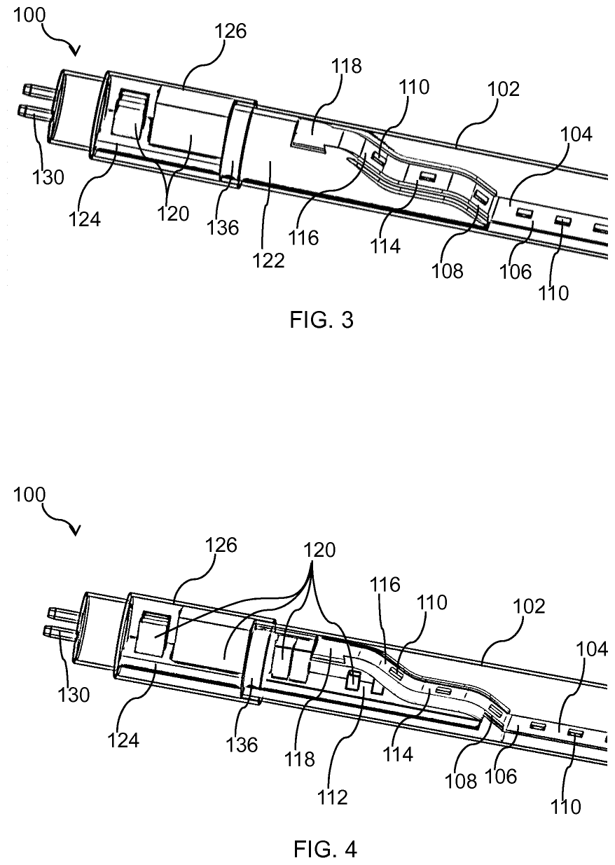

FIG. 3 depicts part of a lighting device 100 with a cutaway portion permitting the components of the driver 120 contained within the end cap 126 to be viewed. Whilst FIGS. 3-6 only depict one end of the lighting device 100, the description of this end may, for instance, apply to the opposing end which is not shown.

The components of the driver 120 are mounted on a support 124 which may extend from an end of the end cap 126 proximal to the pins 130 towards the first section 106. The support 124 may, for instance, comprise a further printed circuit board. The support 124 may, for example, act as a heat sink for dissipating the heat produced by the driver 120 and thus may comprise a suitable heat conductive material, such as a metal or metal alloy. The driver 120 may be adhered to the support 124, for instance, using a glue or adhesive strip.

The end cap 126 may be a push-fit onto an end of the tubular body 102 such that there is an overlapping portion 136 of the end cap 126 and the tubular body 102. Alternatively or additionally, the end cap 126 may be secured to the tubular body 102 by any suitable fastening, e.g. screws, clips, an adhesive and so on.

In an embodiment, a housing 122 may be located within the internal cavity (not visible in FIG. 3 due to being obscured by the housing 122). The housing 122 may be formed of any suitable material, such as a heat conductive material, e.g. a thermally conductive plastic, or a metal such as aluminum.

By forming the housing 122 using an electrically insulating material, such as a plastic, the housing 122 may assist to protect the driver 120 circuitry against electrical short circuits. The housing 122 may, for instance, be formed of a material with both heat conducting and electrical insulating properties, such as a thermally conductive plastic.

The housing 122 may, for instance, comprise a rounded outer surface portion which may match a curved inner surface of the tubular body 102. In this way, the housing 122 may be readily received into the internal cavity and dissipation of heat from the driver 120 which may be located within the housing 122 to the tubular body 102 may be facilitated.

As shown in FIG. 3, the driver 120 may extend from the end cap 126 into the housing 122. The housing 122 may also support the second section 108. In this example, the housing 122 further supports a third section 114 which extends from an end of the second section 108 opposite the first section 106 to form a stepped profile, as previously described. Both the second section 108 and the third section 114 carry a solid state lighting element 110.

In the embodiment shown in FIG. 3, the stepped profile comprises a further step defined by an inclined riser section 116 adjoining a step section 118 extending in a direction of the extension of the third section 114. As shown in FIG. 3, the housing 122 may further support the inclined riser section 116 and the step section 118.

In this example, the inclined riser section 116 carries a solid state lighting element 110 such that the inclined riser section 116 may contribute to an overall luminous output of the carrier 104. Whilst the step section 118 does not carry a solid state lighting element 110 in the example depicted in FIG. 3, this is not intended to be limiting. Alternatively or additionally, at least one solid state lighting element 110 may be carried by the step section 118, which may assist to minimize or prevent the appearance of less well-lit, or ‘darker’, regions of the carrier 104 coinciding with the stepped profile, as previously described.

Considering the other end of the lighting device 100 which is not shown in FIG. 3, the carrier 104 may comprise a further stepped profile having at least one additional step defined by a further inclined riser section adjoining a further step section extending in a direction of said extension of the further third section. Thus the stepped profile depicted in FIG. 3 may, for instance, oppose a further stepped profile located at the opposite end of the lighting device 100. At least one of the further riser section and the further step section may carry at least one solid state lighting element 110. Providing matching stepped profiles at the ends of the tubular body 102 may assist the lighting device 100 to provide a symmetrical lighting effect. This may enhance the aesthetic appeal of the lighting effect produced by the lighting device 100.

FIG. 4 depicts the lighting device 100 shown in FIG. 3 with a further cutaway portion showing the interior of the housing 122. It is evident from FIG. 4 that the housing 122 may occupy the cavity 112 defined by the stepped profile of the carrier 104 and the tubular body 102. The support 124 on which the driver 120 is mounted may extend into the housing 122. In an embodiment, the housing 122 may comprise a slot into which the support 124 is received such that the support 124 is in thermal contact with the housing 122. Accordingly, heat generated by the components of the driver 120 may be dissipated to the housing 122 and to the tubular body 102.

As may be seen in FIG. 4, the components of the driver 120 may be arranged such that the shortest components are located closer to the first section 106. Taller components, i.e. components which extend further from the surface of the support 124, may for example be positioned in the end cap 126 or in portions of the cavity 112 underneath the step section 118. In this way, the available space within the cavity 112 may be more efficiently utilized, as previously described.

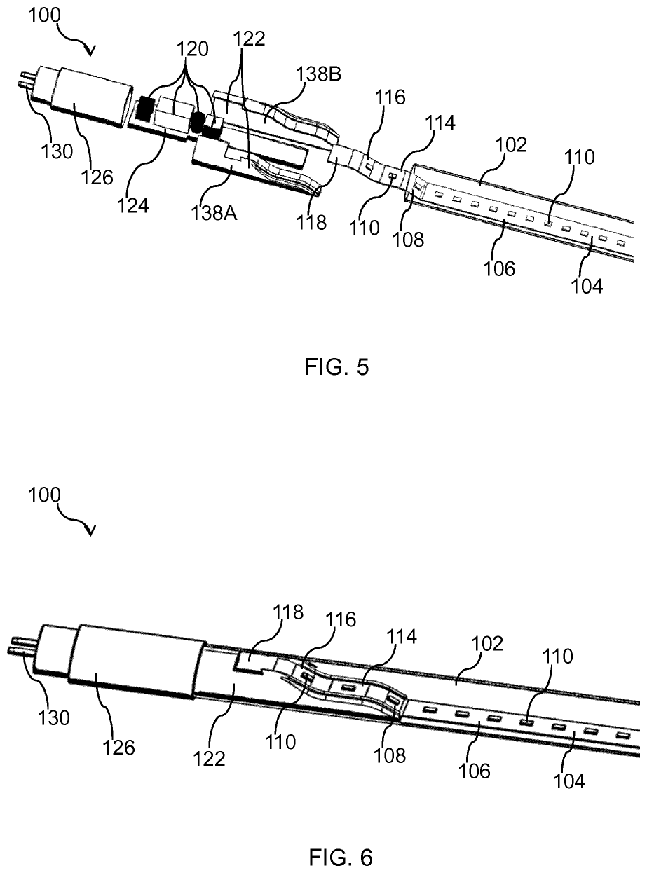

FIG. 5 depicts an exploded view of a lighting device 100 according to an embodiment. FIG. 5 shows how such a lighting device 100 may be assembled. The first section 106 may be received into the tubular body 102. A stepped profile may, in this non-limiting example, extend from an end of the first section 106. The stepped profile may, for instance, comprise a second section 108, a third section 114, an inclined riser section 116, and a step section 118. In this particular example, a flexible printed circuit board may comprise the respective sections. The first section 106 may be supported by the tubular body 102, while the housing 122 may support the other sections.

The stepped profile may, for instance, be supported by a top surface of the housing 122. The top surface may match, and thus support, the stepped profile of the carrier 104. One or more sections of the stepped profile may be adhered to the housing 122 using a glue, adhesive strip, clips, screws etc. By, for instance, using a thermally conductive glue or adhesive strip(s), heat generated by the solid state lighting elements 110 may be more effectively dissipated to the housing 122.

The housing 122 may, for instance, be assembled by joining two half portions 138A and 138B by bringing them together in a direction normal to the elongation direction of the tubular body 102. Upon their joining, the assembled housing 122 may both serve to receive the driver 120 and support the stepped profile. The housing 122 may comprise a slot for receiving the support 124, as previously described. This slot may, for instance correspond to grooves in opposing inner surfaces of the two half portions 138A and 138B. The half portions 138A and 138B may both comprise a rounded outer surface portion such that when they are joined, an outer surface portion of the housing 122 may match a curved inner surface of the tubular body 102, as previously described.

The housing 122 and driver 120 may be received into the tubular body 102. An end cap 126 may, for instance, be fitted onto the end of the tubular body 102 so as to contain the carrier 104, housing 122, and driver 120 inside the resulting assembled lighting device 100. The assembled lighting device 100 is shown in FIG. 6.

The lighting device 100 according to any of the herein embodiments may be advantageously included in a luminaire. The luminaire may be a holder of the lighting device 100, e.g. a ceiling light fitting, an armature for fitting underneath a cabinet or the like, an apparatus into which the lighting device 100 is integrated, e.g. a cooker hood or the like, and so on.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A lighting device comprising:
an elongate tubular body; and
a carrier located inside said tubular body, the carrier comprising a first section and a second section each carrying at least one solid state lighting element, wherein the first section extends in the elongation direction of the tubular body, and the second section extends from an end of the first section at an angle with respect to the first section such that the second section and said tubular body at least partially delimit an internal cavity of the tubular body,
wherein the carrier further comprises a third section carrying at least one solid state lighting element, said third section extending from an end of the second section opposite the first section such that the carrier comprises a stepped profile,
wherein the stepped profile comprises at least one further step defined by an inclined riser section adjoining a step section extending in a direction of extension of the third section, wherein at least one of said riser section and said step section carries at least one solid state lighting element.

2. The lighting device of claim 1, wherein said angle is such that the second section extends from the end of the first section in an inclined manner.

3. The lighting device of claim 1, comprising a driver configured to regulate power supplied to at least one solid state lighting element, wherein the driver is positioned such that it is at least partially contained within said internal cavity.

4. The lighting device of claim 3, wherein a housing is located within the internal cavity, and said driver is located within the housing.

5. The lighting device of claim 4, wherein said housing supports said second section.

6. The lighting device of claim 4, wherein the housing comprises a slot and the driver is mounted on a support dimensioned to fit into said slot so as to be in thermal contact with the housing.

7. The lighting device of claim 3, comprising an end cap at an end of the tubular body, wherein said internal cavity is at least partially delimited by said second section and said end cap, the end cap supporting said driver.

8. The lighting device of claim 1, wherein the carrier comprises a further second section carrying at least one solid state lighting element and extending from a further end of the first section which opposes said end of the first section at a further angle with respect to said first section such that the further second section and the tubular body at least partially delimit a further internal cavity of the tubular body.

9. The lighting device of claim 8, wherein the carrier comprises a further third section carrying at least one solid state lighting element, said further third section extending from an end of said further second section opposite the first section such that the carrier comprises a further stepped profile.

10. The lighting device of claim 9, wherein the further stepped profile comprises at least one additional step defined by a further inclined riser section adjoining a further step section extending in a direction of said extension of the further third section, wherein at least one of said further riser section and said further step section carries at least one solid state lighting element.

11. The lighting device of claim 1, wherein the carrier comprises a flexible printed circuit board comprising the respective sections.

12. The lighting device of claim 1, wherein the carrier comprises separate printed circuit boards for each of the respective sections.

13. A luminaire comprising the lighting device of claim 1.
